(19) United States
(12) Patent Application Publication
(10) Pub. No.: US 2023/0025611 A1
(43) Pub. Date: Jan. 26, 2023

(54) PART DIAGNOSTIC DEVICE, PART DIAGNOSTIC SYSTEM, PART DIAGNOSTIC METHOD, AND PART DIAGNOSTIC PROGRAM

(71) Applicant: TOYOTA JIDOSHA KABUSHIKI KAISHA, Aichi-ken (JP)

(72) Inventors: Masato ENDO, Nagoya-shi (JP); Yasuyuki KAMEZAKI, Toyota-shi (JP); Yasuhiro MURATA, Toyota-shi (JP); Takeo MORIAI, Nagakute-shi (JP); Kosuke SAKAKIBARA, Toyota-shi (JP); Kenta MIYAHARA, Okazaki-shi (JP); Takashi HAYASHI, Nagoya-shi (JP)

(21) Appl. No.: 17/870,823

(22) Filed: Jul. 22, 2022

(30) Foreign Application Priority Data
Jul. 26, 2021 (JP) 2021-121743

(51) Int. Cl. B60W 50/038; G07C 5/00; G07C 5/08

(52) U.S. Cl. CPC B60W 50/038; G07C 5/008; G07C 5/0816

(57) ABSTRACT

A part diagnostic device includes an acquisition unit that acquires vehicle information on a vehicle, an analysis unit that analyzes a vehicle characteristic of the vehicle from the vehicle information acquired by the acquisition unit, and a determination unit that determines whether a part related to the vehicle characteristic is a genuine part based on the vehicle characteristic analyzed by the analysis unit.

### CROSS-REFERENCE TO RELATED APPLICATION

This application claims priority to Japanese Patent Application No. 2021-121743 filed on Jul. 26, 2021, incorporated herein by reference in its entirety.

### BACKGROUND

### 1. Technical Field

The present disclosure relates to a part diagnostic device, a part diagnostic system, a part diagnostic method, and a part diagnostic program.

### 2. Description of Related Art

Japanese Unexamined Patent Application Publication No. 2019-101937 (JP 2019-101937 A) discloses a technique for presenting whether a tire provided to a user is a genuine part or a counterfeit part.

### SUMMARY

The technique described in JP 2019-101937 A is to incorporate a transmitter in a tire and determine whether the tire is a genuine part or a counterfeit part based on information from the transmitter.

Here, the counterfeit part assembled to or replenished in a vehicle is not limited to the tire, but includes many parts such as a brake pad and engine oil. At this time, the technique described in JP 2019-101937 A requires a transmitter to be attached to a part, and cannot be applied to a part in a form in which the transmitter cannot be attached.

Therefore, an object of the present disclosure is to provide a part diagnostic device, a part diagnostic system, a part diagnostic method, and a part diagnostic program that can determine whether a part assembled to or replenished in a vehicle is a genuine part based on information of the vehicle.

A part diagnostic device according to a first aspect of the present disclosure includes an acquisition unit that acquires vehicle information on a vehicle, an analysis unit that analyzes a vehicle characteristic of the vehicle from the vehicle information acquired by the acquisition unit, and a determination unit that determines whether a part related to the vehicle characteristic is a genuine part based on the vehicle characteristic analyzed by the analysis unit.

In the part diagnostic device according to the first aspect, the acquisition unit acquires the vehicle information. Further, the analysis unit analyzes the vehicle characteristic from the vehicle information acquired by the acquisition unit. Then, the determination unit determines whether the part related to the vehicle characteristic is the genuine part based on the vehicle characteristic analyzed by the analysis unit. Thereby, in the part diagnostic device, it is possible to determine whether the part assembled to or replenished in the vehicle is the genuine part based on the vehicle information.

In the part diagnostic device according to a second aspect of the present disclosure, the part diagnostic device includes a notification unit that notifies that the part is not the genuine part when the determination unit determines that the part is not the genuine part.

In the part diagnostic device according to the second aspect, when the determination unit determines that the part is not the genuine part, the notification unit notifies that the part is not the genuine part. Thereby, in the part diagnostic device, it is possible to encourage a driver of the vehicle to use the genuine part when the notification unit notifies that the part is not the genuine part.

In the part diagnostic device according to a third aspect of the present disclosure, the determination unit determines whether the part is the genuine part based on a chronological change in the vehicle characteristic.

In the part diagnostic device according to the third aspect, the determination unit determines whether the part is the genuine part based on the chronological change in the vehicle characteristic. Thereby, in the part diagnostic device, it is possible to accurately determine whether the part is the genuine part as compared with a case where determination is made whether the part is the genuine part based on a temporary change in the vehicle characteristic.

In the part diagnostic device according to a fourth aspect of the present disclosure, the part diagnostic device includes a control unit that limits or stops a travel function of the vehicle when the determination unit determines that the part is not the genuine part.

In the part diagnostic device according to the fourth aspect, the control unit limits or stops the travel function of the vehicle when the determination unit determines that the part is not the genuine part. Thereby, in the part diagnostic device, the travel function of the vehicle is limit or stopped, so that the danger and the malfunction of the vehicle due to the use of the part of which the quality is significantly lower than that of the genuine part can be suppressed.

A part diagnostic system according to a fifth aspect of the present disclosure includes an on-board device mounted on a vehicle, and the part diagnostic device, the part diagnostic device being connected so as to be able to communicate with the on-board device, in which the part diagnostic device includes a storage unit that stores a reference characteristic that serves as a reference for determining whether a part related to a vehicle characteristic of the vehicle is a genuine part.

In a part diagnostic method according to a sixth aspect of the present disclosure, a computer executes processes including acquiring vehicle information on a vehicle, analyzing a vehicle characteristic of the vehicle from the acquired vehicle information, and determining whether a part related to the vehicle characteristic is a genuine part based on the analyzed vehicle characteristic.

A part diagnostic program according to a seventh aspect of the present disclosure causes a computer to execute processes including acquiring vehicle information on a vehicle, analyzing a vehicle characteristic of the vehicle from the acquired vehicle information, and determining whether a part related to the vehicle characteristic is a genuine part based on the analyzed vehicle characteristic.

As described above, the part diagnostic device, the part diagnostic system, the part diagnostic method, and the part diagnostic program according to the present disclosure can determine whether a part assembled to or replenished in a vehicle is a genuine part based on vehicle information.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram showing a schematic configuration of a part diagnostic system according to a first embodiment;

FIG. 2 is a block diagram showing a hardware configuration of a vehicle according to the first embodiment;

FIG. 3 is a block diagram showing an example of a functional configuration of an on-board device according to the first embodiment;

FIG. 4 is a block diagram showing hardware configurations of a driver terminal and an external terminal according to the first embodiment;

FIG. 5 is a flowchart showing a flow of a determination process according to the present embodiment;

FIG. 6 is a diagram showing a schematic configuration of a part diagnostic system according to a second embodiment;

FIG. 7 is a block diagram showing a hardware configuration of a management server according to the second embodiment; and

FIG. 8 is a block diagram showing an example of a functional configuration of the management server according to the second embodiment.

### DETAILED DESCRIPTION OF EMBODIMENTS

### First Embodiment

Hereinafter, a part diagnostic system 10 according to a first embodiment will be described.

The part diagnostic system 10 according to the first embodiment is a system for determining whether parts related to vehicle characteristics of a vehicle, for example, a brake pad and engine oil of the vehicle are genuine parts. Here, the genuine part includes a genuine part manufactured or sold by a manufacturer of a vehicle, and a compatible part that is a part manufactured or sold by a person other than the manufacturer of the vehicle and recommended or allowed to be used by the manufacturer.

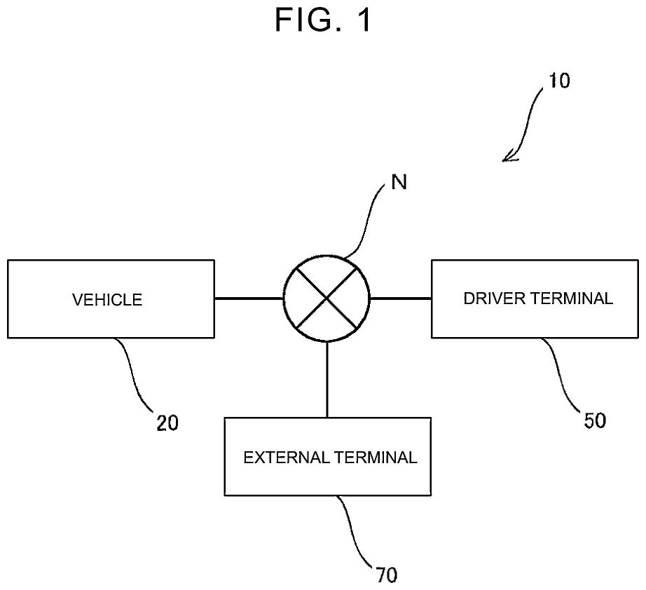

FIG. 1 is a diagram showing a schematic configuration of the part diagnostic system 10 according to the first embodiment.

As shown in FIG. 1, the part diagnostic system 10 includes a vehicle 20, a driver terminal 50, and an external terminal 70. The vehicle 20, the driver terminal 50, and the external terminal 70 are connected via a network N, and are able to communicate with each other.

The vehicle 20 may be a gasoline vehicle, a hybrid electric vehicle, or a battery electric vehicle. However, in the first embodiment, the vehicle 20 is a gasoline vehicle as an example.

The driver terminal 50 is a mobile terminal owned by a driver of the vehicle 20. As an example, a portable personal computer (laptop PC), a smartphone, a tablet terminal, or the like is applied to the driver terminal 50. In the first embodiment, as an example, the driver terminal 50 is a smartphone.

The external terminal 70 is a terminal owned by a predetermined business operator such as a manufacturer and a seller of the vehicle 20. A general-purpose computer device such as a server computer or a PC, or a mobile terminal such as a laptop PC, a smartphone, or a tablet terminal is applied to the external terminal 70. In the first embodiment, as an example, the external terminal 70 is a smartphone.

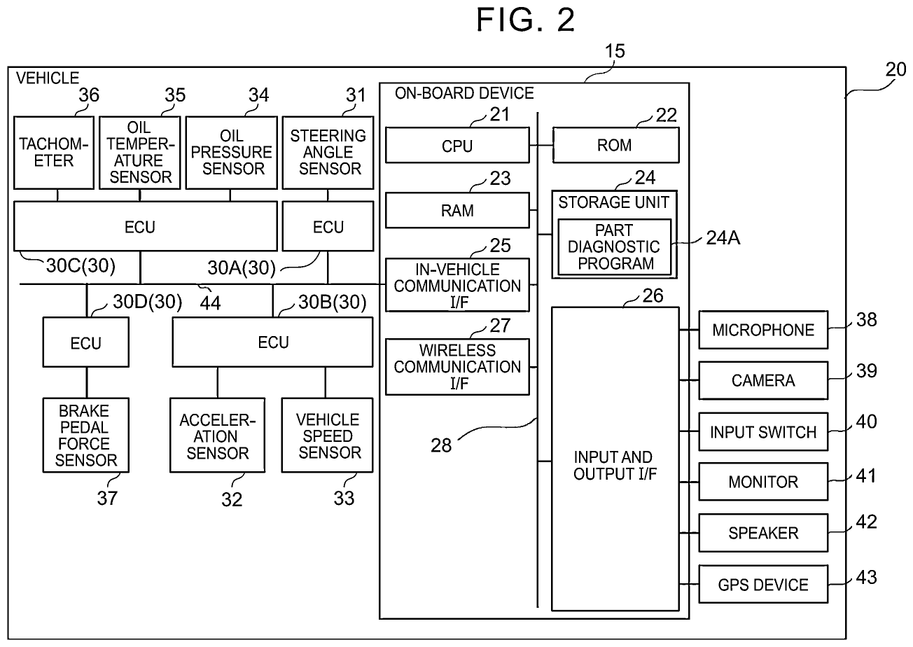

Next, a hardware configuration of the vehicle 20 will be described. FIG. 2 is a block diagram showing the hardware configuration of the vehicle 20.

As shown in FIG. 2, the vehicle 20 is configured to include an on-board device 15, a plurality of electronic control units (ECUs) 30, a steering angle sensor 31, an acceleration sensor 32, a vehicle speed sensor 33, an oil pressure sensor 34, an oil temperature sensor 35, a tachometer 36, a brake pedal force sensor 37, a microphone 38, a camera 39, an input switch 40, a monitor 41, a speaker 42, and a global positioning system (GPS) device 43. The on-board device 15 is an example of a “part diagnostic device”.

The on-board device 15 is configured to include a central processing unit (CPU) 21, a read-only memory (ROM) 22, a random access memory (RAM) 23, a storage unit 24, an in-vehicle communication interface (I/F) 25, an input and output I/F 26, and a wireless communication I/F 27. The CPU 21, the ROM 22, the RAM 23, the storage unit 24, the in-vehicle communication I/F 25, the input and output I/F 26, and the wireless communication I/F 27 are connected to each other so as to be able to communicate with each other via an internal bus 28.

The CPU 21 is a central processing unit that executes various programs and that controls various units. That is, the CPU 21 reads the program from the ROM 22 or the storage unit 24 and executes the program using the RAM 23 as a work area. The CPU 21 controls each of the above configurations and performs various arithmetic processes in accordance with the program recorded in the ROM 22 or the storage unit 24.

The ROM 22 stores various programs and various data. The RAM 23 temporarily stores a program or data as a work area.

The storage unit 24 is composed of a storage device such as a hard disk drive (HDD), a solid state drive (SSD), or a flash memory, and stores various programs and various data. In the first embodiment, the storage unit 24 stores at least a part diagnostic program 24A for executing a determination process that will be described below.

Further, the storage unit 24 stores first determination data based on a brake pedal force, acceleration, and a vehicle speed of the vehicle 20 serving as a reference, and second determination data based on an engine speed of the vehicle 20, and oil pressure and an oil temperature of engine oil serving as a reference, as reference characteristics serving as a reference for determining whether the parts related to the vehicle characteristics of the vehicle 20 are genuine parts. As an example, the storage unit 24 stores time-series data of each of the first determination data and the second determination data from the time of purchase of the vehicle 20 to a predetermined time.

The in-vehicle communication I/F 25 is an interface for connecting to the ECUs 30. For the interface, a communication standard based on a controller area network (CAN) protocol is used. The in-vehicle communication I/F 25 is connected to an external bus 44.

The ECUs 30 are provided for respective functions of the vehicle 20, and in the first embodiment, an ECU 30A, an ECU 30B, an ECU 30C, and an ECU 30D are provided. The ECU 30A is exemplified by an electric power steering ECU, and the steering angle sensor 31 is connected to the ECU 30A. Further, the ECU 30B is exemplified by a vehicle stability control (VSC) ECU, and the acceleration sensor 32 and the vehicle speed sensor 33 are connected to the ECU 30B. In addition to the acceleration sensor 32 and the vehicle speed sensor 33, a yaw rate sensor may be connected to the ECU 30B. Further, the ECU 30C is exemplified by an engine ECU, and the oil pressure sensor 34, the oil temperature sensor 35, and the tachometer 36 are connected to the ECU 30C. Further, the ECU 30D is exemplified by a brake ECU, and the brake pedal force sensor 37 is connected to the ECU 30D.

The steering angle sensor 31 is a sensor for detecting steering angle of a steering wheel. The steering angle detected by the steering angle sensor 31 is stored in the storage unit 24 as vehicle information.

The acceleration sensor 32 is a sensor for detecting acceleration acting on the vehicle 20. The acceleration sensor 32 is, for example, a three-axis acceleration sensor that detects the acceleration applied in the vehicle front-rear direction as the X-axis direction, the vehicle width direction as the Y-axis direction, and the vehicle height direction as the Z-axis direction. The acceleration detected by the acceleration sensor 32 is stored in the storage unit 24 as vehicle information.

The vehicle speed sensor 33 is a sensor for detecting a vehicle speed of the vehicle 20. The vehicle speed sensor 33 is, for example, a sensor provided on a wheel. The vehicle speed detected by the vehicle speed sensor 33 is stored in the storage unit 24 as vehicle information.

The oil pressure sensor 34 is a sensor for detecting oil pressure of the engine oil of the vehicle 20. The oil pressure of the engine oil detected by the oil pressure sensor 34 is stored in the storage unit 24 as vehicle information.

The oil temperature sensor 35 is a sensor for detecting an oil temperature of the engine oil of the vehicle 20. The oil temperature of the engine oil detected by the oil temperature sensor 35 is stored in the storage unit 24 as vehicle information.

The tachometer 36 detects an engine speed of the vehicle 20. The engine speed detected by the tachometer 36 is stored in the storage unit 24 as vehicle information.

The brake pedal force sensor 37 is a sensor for detecting a depression force of a brake pedal (not shown) by the driver of the vehicle 20, that is, a brake pedal force. The brake pedal force detected by the brake pedal force sensor 37 is stored in the storage unit 24 as vehicle information.

The input and output I/F 26 is an interface for communicating with the microphone 38, the camera 39, the input switch 40, the monitor 41, the speaker 42, and the GPS device 43 mounted on the vehicle 20.

The microphone 38 is a device provided on a front pillar, a dashboard, or the like of the vehicle 20, and collects voices emitted by the driver of the vehicle 20. The microphone 38 may be provided in the camera 39 that will be described below.

The camera 39 is configured to include a charge coupled device (CCD) image sensor as an example. The camera 39 is provided, for example, at the front portion of the vehicle 20 and captures an image of the front of the vehicle 20. The image captured by the camera 39 is used, for example, for recognizing an inter-vehicle distance with a preceding vehicle traveling in front of the vehicle 20, lanes, traffic lights, and the like. The image captured by the camera 39 is stored in the storage unit 24 as vehicle information. Note that, the camera 39 may be configured as an imaging device for other purposes such as a driving recorder. Further, the camera 39 may be connected to the on-board device 15 via the ECU 30 (for example, a camera ECU).

The input switch 40 is provided on an instrument panel, a center console, the steering wheel, or the like, and is a switch for inputting an operation by fingers of the driver. As the input switch 40, for example, a push button type numeric keypad, a touch pad, or the like can be adopted.

The monitor 41 is a liquid crystal monitor provided on the instrument panel, a meter panel, or the like, for displaying an image of an operation proposal related to a function of the vehicle 20 and an explanation of the function. The monitor 41 may be provided as a touch panel that also serves as the input switch 40.

The speaker 42 is a device provided on the instrument panel, the center console, the front pillar, the dashboard, or the like, for outputting a voice for the operation proposal related to the function of the vehicle 20 and the explanation of the function. The speaker 42 may be provided on the monitor 41.

The GPS device 43 is a device that measures a current position of the vehicle 20. The GPS device 43 includes an antenna (not shown) that receives signals from GPS satellites. Note that, the GPS device 43 may be connected to the on-board device 15 via a car navigation system connected to the ECU 30 (for example, a multimedia ECU).

The wireless communication I/F 27 is a wireless communication module for communicating with other devices. For the wireless communication module, for example, communication standards such as fifth generation (5G), long term evolution (LTE), and Wi-Fi (registered trademark) are used. The wireless communication I/F 27 is connected to the network N.

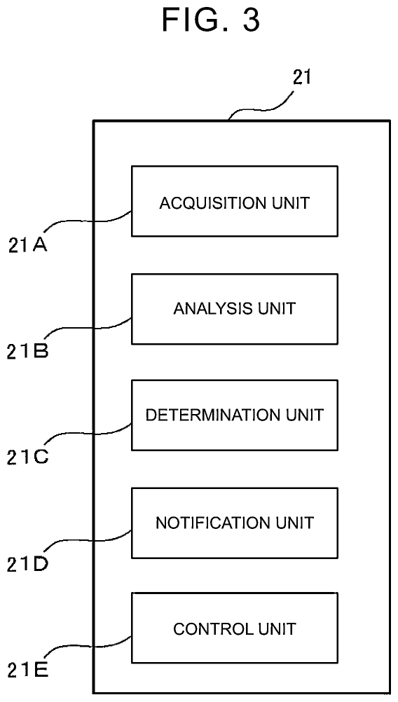

Next, a functional configuration of the on-board device 15 will be described. FIG. 3 is a block diagram showing an example of the functional configuration of the on-board device 15 according to the first embodiment.

As shown in FIG. 3, the CPU 21 of the on-board device 15 includes an acquisition unit 21A, an analysis unit 21B, a determination unit 21C, a notification unit 21D, and a control unit 21E as functional configurations. Each functional configuration is realized when the CPU 21 reads and executes the part diagnostic program 24A stored in the storage unit 24.

The acquisition unit 21A acquires vehicle information on the vehicle 20. As an example, the acquisition unit 21A acquires, as the vehicle information, the acceleration of the vehicle 20 detected by the acceleration sensor 32, the vehicle speed of the vehicle 20 detected by the vehicle speed sensor 33, the oil pressure of the engine oil detected by the oil pressure sensor 34, the oil temperature of the engine oil detected by the oil temperature sensor 35, the engine speed of the vehicle 20 detected by the tachometer 36, and the brake pedal force by the driver detected by the brake pedal force sensor 37, at least from the storage unit 24. The above information is part of the vehicle information that can be acquired by the acquisition unit 21A, and the acquisition unit 21A can also acquire information on the vehicle 20 other than the above information from the storage unit 24 as the vehicle information.

The analysis unit 21B analyzes the vehicle characteristics of the vehicle 20 from the vehicle information acquired by the acquisition unit 21A. As an example, the analysis unit 21B analyzes deceleration of the vehicle 20 during braking and an engine malfunction of the vehicle 20 as the vehicle characteristics.

Based on the vehicle characteristics analyzed by the analysis unit 21B, the determination unit 21C determines whether the parts related to the vehicle characteristics, for example, the brake pad and the engine oil of the vehicle 20 are genuine parts. Specifically, the determination unit 21C determines whether the brake pad and the engine oil are genuine parts based on a chronological change in the vehicle characteristics.

As an example, the determination unit 21C compares changes in the brake pedal force, the acceleration, and the vehicle speed of the vehicle 20 acquired as the vehicle information within a predetermined period from the time of purchase of the vehicle 20 to a predetermined time, which have been analyzed by the analysis unit 21B, with the first determination data stored in the storage unit 24 corresponding to the predetermined period, and determines whether the brake pad is a genuine part based on the comparison result.

Further, the determination unit 21C compares changes in the engine speed of the vehicle 20, and the oil pressure and the oil temperature of the engine oil acquired as the vehicle information within a predetermined period from the time of purchase of the vehicle 20 to a predetermined time, which have been analyzed by the analysis unit 21B, with the second determination data stored in the storage unit 24 corresponding to the predetermined period, and determines whether the engine oil is a genuine part based on the comparison result.

When the determination unit 21C determines that at least one of the brake pad and the engine oil is not a genuine part, the notification unit 21D notifies that the determined part is not a genuine part (hereinafter referred to as “counterfeit part notification”). In the first embodiment, as an example, the notification unit 21D notifies the inside and outside of the vehicle 20 of the counterfeit part notification.

Specifically, the notification unit 21D causes the monitor 41 as the inside of the vehicle 20 to display the counterfeit part notification. Although not shown, the notification unit 21D displays on the monitor 41 a notification such as “The brake pad currently installed is not a genuine part” as an example of the counterfeit part notification.

Further, the notification unit 21D transmits the counterfeit part notification to the external terminal 70 as the outside of the vehicle 20. Although not shown, the external terminal 70 that has received the counterfeit part notification displays on a display unit 76 described below a notification such as “The brake pad currently installed on the vehicle of Mr./Ms. XX is not a genuine part” as an example of the counterfeit part notification.

The control unit 21E limits or stops a travel function of the vehicle 20 when the determination unit 21C determines that at least one of the brake pad and the engine oil is not a genuine part. In the first embodiment, as an example, when the determination unit 21C determines that the brake pad is not a genuine part, the control unit 21E limits the travel function of the vehicle 20 and allows the vehicle 20 to travel only at a predetermined vehicle speed or lower. Further, when the determination unit 21C determines that the engine oil is not a genuine part, the control unit 21E limits the travel function of the vehicle 20 and imposes a limit on the engine speed. When the control unit 21E stops the travel function of the vehicle 20, as an example, starting the engine is prohibited.

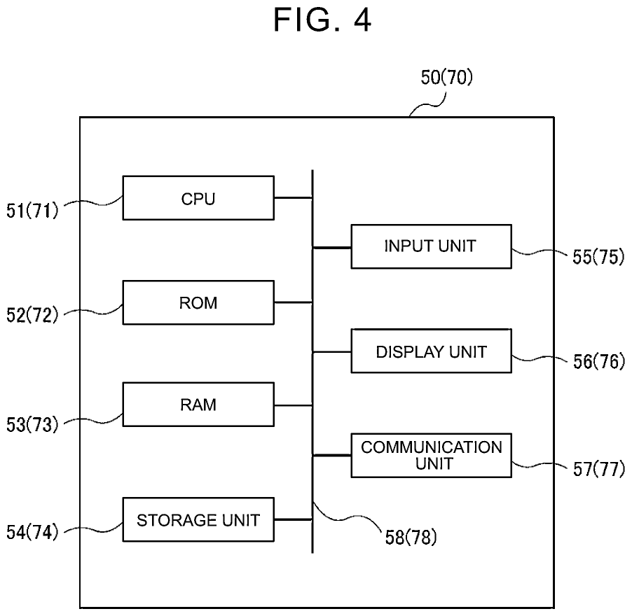

Next, hardware configurations of the driver terminal 50 and the external terminal 70 will be described. FIG. 4 is a block diagram showing the hardware configurations of the driver terminal 50 and the external terminal 70. Since the driver terminal 50 and the external terminal 70 basically have general computer configurations, the driver terminal 50 will be described as a representative.

As shown in FIG. 4, the driver terminal 50 includes a CPU 51, a ROM 52, a RAM 53, a storage unit 54, an input unit 55, a display unit 56, and a communication unit 57. The configurations are connected so as to be able to communicate with each other via a bus 58.

The CPU 51 is a central processing unit that executes various programs and that controls various units. That is, the CPU 51 reads the program from the ROM 52 or the storage unit 54 and executes the program using the RAM 53 as a work area. The CPU 51 controls each of the above configurations and performs various arithmetic processes in accordance with the program recorded in the ROM 52 or the storage unit 54.

The ROM 52 stores various programs and various data. The RAM 53 temporarily stores a program or data as a work area.

The storage unit 54 is composed of a storage device such as an HDD, an SSD, or a flash memory, and stores various programs and various data.

The input unit 55 includes various buttons, a microphone, a camera, and the like, and is used for performing various inputs.

The display unit 56 is, for example, a liquid crystal display and displays various kinds of information. A touch panel is adopted as the display unit 56 and functions as the input unit 55.

The communication unit 57 is an interface for communicating with other devices. For the communication, for example, a wired communication standard such as Ethernet (registered trademark) or fiber-distributed data interface (FDDI), or a wireless communication standard such as fourth generation (4G), 5G, or Wi-Fi (registered trademark) is used.

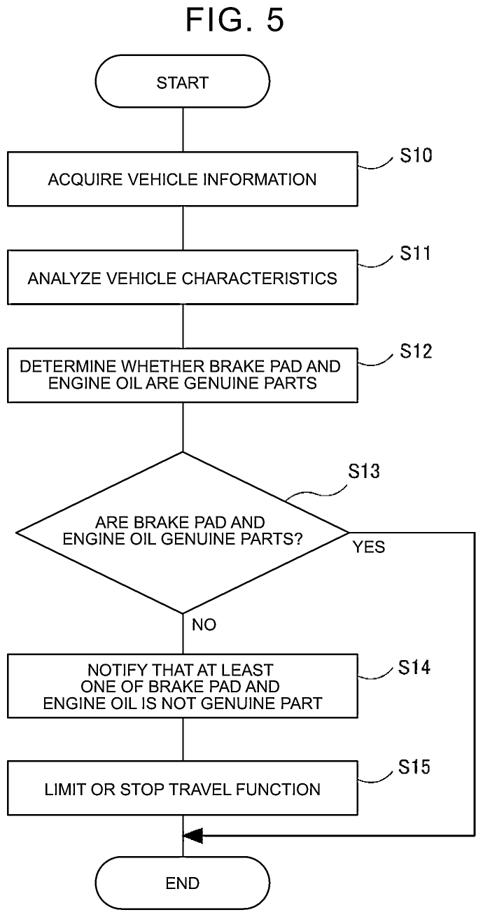

FIG. 5 is a flowchart showing a flow of a determination process for determining whether the parts related to the vehicle characteristics of the vehicle 20 are genuine parts. The determination process is executed when the CPU 21 reads the part diagnostic program 24A from the storage unit 24, expands the part diagnostic program 24A into the RAM 23, and executes the program.

In step S10 shown in FIG. 5, the CPU 21 acquires the acceleration, the vehicle speed, the engine speed, the brake pedal force of the vehicle 20, and the oil pressure and the oil temperature of the engine oil, as the vehicle information from the storage unit 24. Then, the process proceeds to step S11. As an example, the CPU 21 periodically acquires the vehicle information from the storage unit 24.

In step S11, the CPU 21 analyzes the deceleration of the vehicle 20 during braking and the engine malfunction of the vehicle 20 as the vehicle characteristics of the vehicle 20, from the vehicle information acquired in step S10. Then, the process proceeds to step S12.

In step S12, based on the vehicle characteristics analyzed in step S11, as the parts related to the vehicle characteristics, the CPU 21 determines whether the brake pad and the engine oil of the vehicle 20 are genuine parts. Then, the process proceeds to step S13.

In step S13, when the CPU 21 determines in step S12 that both the brake pad and the engine oil are not genuine parts (step S13: NO), the process proceeds to step S14. On the other hand, when the CPU 21 determines in step S12 that both the brake pad and the engine oil are genuine parts (step S13: YES), the process ends.

In step S14, the CPU 21 notifies the inside and outside of the vehicle 20 of the counterfeit part notification. As an example, the CPU 21 causes the monitor 41 as the inside of the vehicle 20 to display the counterfeit part notification, and transmits the counterfeit part notification to the external terminal 70 as the outside of the vehicle 20. Then, the process proceeds to step S15.

In step S15, the CPU 21 limits or stops the travel function of the vehicle 20. As an example, when the CPU 21 determines that the brake pad is not a genuine part, the CPU 21 limits the travel function of the vehicle 20, allows the vehicle 20 to travel only at a predetermined vehicle speed or lower. When the CPU 21 determines that the engine oil is not a genuine part, the CPU 21 limits the travel function of the vehicle 20 and imposes a limit on the engine speed. Then, the process ends.

As described above, in the first embodiment, the CPU 21 acquires the vehicle information. Further, the CPU 21 analyzes the vehicle characteristics from the acquired vehicle information. Then, the CPU 21 determines whether the parts related to the vehicle characteristics are genuine parts based on the analyzed vehicle characteristics. Thereby, in the first embodiment, it is possible to determine whether the parts assembled to or replenished in the vehicle 20 are genuine parts based on the vehicle information.

Further, in the first embodiment, when the CPU 21 determines that the parts related to the vehicle characteristics are not genuine parts, the CPU 21 notifies that the parts are not genuine parts. Thereby, in the first embodiment, it is possible to encourage the driver of the vehicle 20 to use the genuine part when the CPU 21 notifies that the parts are not genuine parts.

Further, in the first embodiment, the CPU 21 determines whether the parts related to the vehicle characteristics are genuine parts based on a chronological change in the vehicle characteristics. Thereby, in the first embodiment, it is possible to accurately determine whether the parts are genuine parts as compared with a case where determination is made whether the parts are genuine parts based on a temporary change in the vehicle characteristics.

Further, in the first embodiment, the CPU 21 limits or stops the travel function of the vehicle 20 when the CPU 21 determines that the parts related to the vehicle characteristics are not genuine parts. Thereby, in the first embodiment, the travel function of the vehicle 20 is limit or stopped, so that the danger and the malfunction of the vehicle 20 due to the use of the part of which the quality is significantly lower than that of the genuine part can be suppressed.

### Second Embodiment

Next, a second embodiment will be described while omitting or simplifying the overlapping portion with the other embodiments.

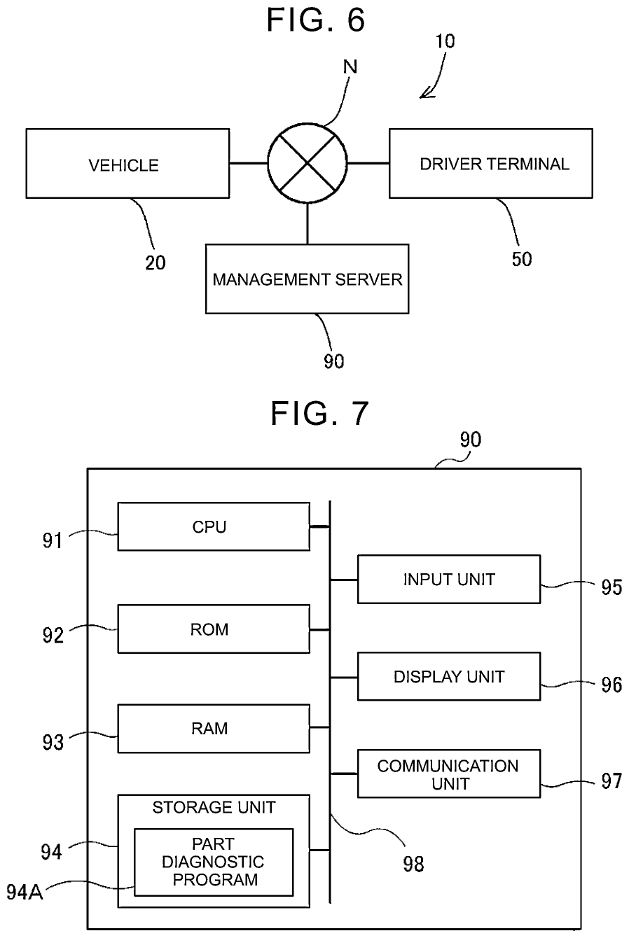

FIG. 6 is a diagram showing a schematic configuration of the part diagnostic system 10 according to the second embodiment.

As shown in FIG. 6, the part diagnostic system 10 includes the vehicle 20, the driver terminal 50, and a management server 90. The vehicle 20, the driver terminal 50, and the management server 90 are connected via the network N, and are able to communicate with each other. The management server 90 is an example of a “part diagnostic device”.

The management server 90 is a server computer owned by a predetermined business operator, and is connected so as to be able to communicate with the on-board device 15 mounted on the vehicle 20.

Here, unlike the first embodiment, the part diagnostic system 10 according to the second embodiment determines whether the brake pad and the engine oil of the vehicle 20 are genuine parts by the management server 90.

Next, a hardware configuration of the management server 90 will be described. FIG. 7 is a block diagram showing the hardware configuration of the management server 90.

As shown in FIG. 7, the management server 90 includes a CPU 91, a ROM 92, a RAM 93, a storage unit 94, an input unit 95, a display unit 96, and a communication unit 97. The configurations are connected so as to be able to communicate with each other via a bus 98.

The CPU 91 is a central processing unit that executes various programs and that controls various units. That is, the CPU 91 reads the program from the ROM 92 or the storage unit 94 and executes the program using the RAM 93 as a work area. The CPU 91 controls each of the above configurations and performs various arithmetic processes in accordance with the program recorded in the ROM 92 or the storage unit 94.

The ROM 92 stores various programs and various data. The RAM 93 temporarily stores a program or data as a work area.

The storage unit 94 is composed of a storage device such as an HDD, an SSD, or a flash memory, and stores various programs and various data. In the second embodiment, the storage unit 94 stores at least a part diagnostic program 94A. Further, the storage unit 94 stores the first determination data and the second determination data as the reference characteristics of the vehicle 20. As an example, the storage unit 94 stores time-series data of each of the first determination data and the second determination data from the time of purchase of the vehicle 20 to a predetermined time. The storage unit 94 is an example of a “storage unit”.

The input unit 95 includes a pointing device such as a mouse, a keyboard, a microphone, a camera, and the like, and is used for performing various inputs.

The display unit 96 is, for example, a liquid crystal display and displays various kinds of information. A touch panel may be adopted as the display unit 96 and may function as the input unit 95.

The communication unit 97 is an interface for communicating with other devices. For the communication, for example, a wired communication standard such as Ethernet (registered trademark) or FDDI, or a wireless communication standard such as 4G, 5G, or Wi-Fi (registered trademark) is used.

When executing the above-mentioned part diagnostic program 94A, the management server 90 executes the processes based on the above-mentioned part diagnostic program 94A using the above-mentioned hardware resources.

Next, a functional configuration of the management server 90 will be described.

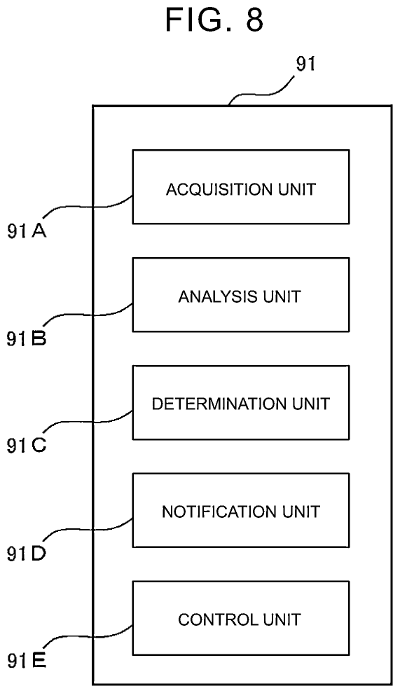

FIG. 8 is a block diagram showing an example of the functional configuration of the management server 90 according to the second embodiment.

As shown in FIG. 8, the CPU 91 of the management server 90 includes an acquisition unit 91A, an analysis unit 91B, a determination unit 91C, a notification unit 91D, and a control unit 91E as functional configurations. Each functional configuration is realized when the CPU 91 reads and executes the part diagnostic program 94A stored in the storage unit 94.

The acquisition unit 91A acquires vehicle information on the vehicle 20. As an example, the acquisition unit 91A acquires, as the vehicle information, the acceleration of the vehicle 20 detected by the acceleration sensor 32, the vehicle speed of the vehicle 20 detected by the vehicle speed sensor 33, the oil pressure of the engine oil detected by the oil pressure sensor 34, the oil temperature of the engine oil detected by the oil temperature sensor 35, the engine speed of the vehicle 20 detected by the tachometer 36, and the brake pedal force by the driver detected by the brake pedal force sensor 37, at least from the vehicle 20. The above information is part of the vehicle information that can be acquired by the acquisition unit 91A from the vehicle 20, and the acquisition unit 91A can also acquire information on the vehicle 20 other than the above information from the vehicle 20 as the vehicle information.

The analysis unit 91B analyzes the deceleration of the vehicle 20 during braking and the engine malfunction of the vehicle 20 as the vehicle characteristics of the vehicle 20 from the vehicle information acquired by the acquisition unit 91A.

Based on the vehicle characteristics analyzed by the analysis unit 91B, the determination unit 91C determines whether the parts related to the vehicle characteristics, for example, the brake pad and the engine oil of the vehicle 20 are genuine parts. Specifically, the determination unit 91C determines whether the brake pad and the engine oil are genuine parts based on a chronological change in the vehicle characteristics.

As an example, the determination unit 91C compares changes in the brake pedal force, the acceleration, and the vehicle speed of the vehicle 20 acquired as the vehicle information within a predetermined period from the time of purchase of the vehicle 20 to a predetermined time, which have been analyzed by the analysis unit 91B, with the first determination data stored in the storage unit 94 corresponding to the predetermined period, and determines whether the brake pad is a genuine part based on the comparison result.

Further, the determination unit 91C compares changes in the engine speed of the vehicle 20, and the oil pressure and the oil temperature of the engine oil acquired as the vehicle information within a predetermined period from the time of purchase of the vehicle 20 to a predetermined time, which have been analyzed by the analysis unit 91B, with the second determination data stored in the storage unit 94 corresponding to the predetermined period, and determines whether the engine oil is a genuine part based on the comparison result.

When the determination unit 91C determines that at least one of the brake pad and the engine oil is not a genuine part, the notification unit 91D notifies the inside of the vehicle 20 of the counterfeit part notification.

Specifically, the notification unit 91D transmits the counterfeit part notification to the vehicle 20. Although not shown, the vehicle 20 that has received the counterfeit part notification displays on the monitor 41 provided inside the vehicle 20 a notification such as “The brake pad currently installed is not a genuine part” as an example of the counterfeit part notification.

The control unit 91E transmits an instruction for limiting or stopping the travel function of the vehicle 20 to the vehicle 20 when the determination unit 91C determines that at least one of the brake pad and the engine oil is not a genuine part. In the second embodiment, as an example, the control unit 91E transmits the instruction for limiting the travel function of the vehicle 20 to the vehicle 20.

Next, a flow of a determination process for determining whether the brake pad and the engine oil of the vehicle 20 are genuine parts by the management server 90 will be described. The flow of the determination process by the management server 90 is shown in the flowchart of FIG. 5, as in the first embodiment. The determination process is executed when the CPU 91 reads the part diagnostic program 94A from the storage unit 94, expands the part diagnostic program 94A into the RAM 93, and executes the program.

In step S10 shown in FIG. 5, the CPU 91 acquires the acceleration, the vehicle speed, the engine speed, the brake pedal force of the vehicle 20, and the oil pressure and the oil temperature of the engine oil, as the vehicle information from the vehicle 20. Then, the process proceeds to step S11. In the second embodiment, as an example, the vehicle information is periodically transmitted from the vehicle 20 to the management server 90.

In step S11, the CPU 91 analyzes the deceleration of the vehicle 20 during braking and the engine malfunction of the vehicle 20 as the vehicle characteristics of the vehicle 20, from the vehicle information acquired in step S10. Then, the process proceeds to step S12.

In step S12, based on the vehicle characteristics analyzed in step S11, as the parts related to the vehicle characteristics, the CPU 91 determines whether the brake pad and the engine oil of the vehicle 20 are genuine parts. Then, the process proceeds to step S13.

In step S13, when the CPU 91 determines in step S12 that both the brake pad and the engine oil are not genuine parts (step S13: NO), the process proceeds to step S14. On the other hand, when the CPU 91 determines in step S12 that both the brake pad and the engine oil are genuine parts (step S13: YES), the process ends.

In step S14, the CPU 91 notifies the inside of the vehicle 20 of the counterfeit part notification. As an example, the CPU 91 transmits the counterfeit part notification to the vehicle 20, and causes the monitor 41 provided inside the vehicle 20 to display the counterfeit part notification. Then, the process proceeds to step S15.

In step S15, the CPU 91 transmits the instruction for limiting or stopping the travel function of the vehicle 20 to the vehicle 20. As an example, the CPU 91 transmits the instruction for limiting the travel function of the vehicle 20 to the vehicle 20. Then, the process ends.

### Others

In the above embodiment, the driver terminal 50 is provided as a mobile terminal owned by the driver of the vehicle 20, but an applicable embodiment of the present disclosure is not limited to this, and the driver terminal 50 may be a general-purpose computer device such as a server computer or a PC.

In the above embodiment, the counterfeit part notification is displayed on the monitor 41 as the inside of the vehicle 20, but an applicable embodiment of the present disclosure is not limited to this, and the counterfeit part notification may be output in voice from the speaker 42 as the inside of the vehicle 20.

In the above embodiment, the counterfeit part notification is transmitted to the external terminal 70 as the outside of the vehicle 20, but an applicable embodiment of the present disclosure is not limited to this, and the counterfeit part notification may be transmitted to other terminals such as the driver terminal 50 as the outside of the vehicle 20.

In the above embodiment, the deceleration of the vehicle 20 is detected by using the acceleration sensor 32, but an applicable embodiment of the present disclosure is not limited to this, and the deceleration of the vehicle 20 may be detected based on the change in the vehicle speed detected by the vehicle speed sensor 33.

In the above embodiment, the second determination data is based on the engine speed of the vehicle 20, and the oil pressure and the oil temperature of the engine oil serving as a reference, but the various data constituting the second determination data is not limited to these, and may include other data such as vibration of an engine.

It should be noted that various processors other than the CPU may execute the determination process that is executed when the CPU 21 or the CPU 91 reads the software (program) in the above embodiment. Examples of the processors in this case include a programmable logic device (PLD) such as a field-programmable gate array (FPGA) for which a circuit configuration can be changed after production, a dedicated electric circuit that is a processor having a circuit configuration designed exclusively for executing a specific process, such as an application specific integrated circuit (ASIC), and the like. Further, the determination process may be executed by one of these various processors, or a combination of two or more processors of the same type or different types (for example, a combination of FPGAs, a combination of a CPU and an FPGA, and the like). Further, the hardware structure of each of the various processors is, more specifically, an electric circuit in which circuit elements such as semiconductor elements are combined.

Further, in the above embodiment, the mode in which the part diagnostic program 24A and the part diagnostic program 94A are stored (installed) in advance in the storage unit 24 and the storage unit 94, respectively, has been described, but an applicable embodiment of the present disclosure is not limited to this. The part diagnostic program 24A and the part diagnostic program 94A may be stored in a storage medium such as a compact disc read-only memory (CD-ROM), a digital versatile disc read-only memory (DVD-ROM), and a universal serial bus (USB) memory to be provided. Further, the part diagnostic program 24A and the part diagnostic program 94A may be downloaded from an external device via the network N.

What is claimed is:

1. A part diagnostic device comprising:
an acquisition unit that acquires vehicle information on a vehicle;
an analysis unit that analyzes a vehicle characteristic of the vehicle from the vehicle information acquired by the acquisition unit; and
a determination unit that determines whether a part related to the vehicle characteristic is a genuine part based on the vehicle characteristic analyzed by the analysis unit.

2. The part diagnostic device according to claim 1, comprising a notification unit that notifies that the part is not the genuine part when the determination unit determines that the part is not the genuine part.

3. The part diagnostic device according to claim 1, wherein the determination unit determines whether the part is the genuine part based on a chronological change in the vehicle characteristic.

4. The part diagnostic device according to claim 1, comprising a control unit that limits or stops a travel function of the vehicle when the determination unit determines that the part is not the genuine part.

5. A part diagnostic system comprising:
an on-board device mounted on a vehicle; and
the part diagnostic device according to claim 1, the part diagnostic device being connected so as to be able to communicate with the on-board device, wherein the part diagnostic device includes a storage unit that stores a reference characteristic that serves as a reference for determining whether a part related to a vehicle characteristic of the vehicle is a genuine part.

6. A part diagnostic method in which a computer executes processes comprising:
acquiring vehicle information on a vehicle;
analyzing a vehicle characteristic of the vehicle from the acquired vehicle information; and
determining whether a part related to the vehicle characteristic is a genuine part based on the analyzed vehicle characteristic.

7. A part diagnostic program that causes a computer to execute processes comprising:
acquiring vehicle information on a vehicle;
analyzing a vehicle characteristic of the vehicle from the acquired vehicle information; and
determining whether a part related to the vehicle characteristic is a genuine part based on the analyzed vehicle characteristic.
